(19) United States
(12) Patent Application Publication
(10) Pub. No.: US 2016/0189099 A1
(43) Pub. Date: Jun. 30, 2016

(54) SHIPPING OPTION SELECTION BASED ON VIRTUAL SHOPPING CART CONVERSION DATA

(71) Applicant: eBay Inc., San Jose, CA (US)

(72) Inventors: Muhammad Arif Iqbal, San Jose, CA (US); Farah Mariam Ali, San Jose, CA (US)

(21) Appl. No.: 14/586,752

(22) Filed: Dec. 30, 2014

(51) Int. Cl. G06Q 10/08; G06Q 30/06

(52) U.S. Cl. CPC G06Q 10/0838; G06Q 30/0633

(57) ABSTRACT

Systems and methods are disclosed to receive an indication that a buyer has placed an item in a virtual shopping cart. One or more conversion shipping options associated with shipping options used to ship one or more previously purchased items purchased by the buyer may be determined. One or more non-conversion shipping options associated with shipping options presented to the buyer with one or more unpurchased items previously placed in a virtual shopping cart by the buyer but not purchased by the buyer may be determined. A plurality of conversion probabilities may be determined for a plurality of different shipping options for the item in the virtual shopping cart based at least in part on the conversion shipping options and the non-conversion shipping options. In some embodiments, a shipping option may be selected based on the plurality of different shipping options and the plurality of conversion probabilities.

### FIELD

This disclosure relates generally to selecting shipping options to present to a user based on virtual shopping cart conversion data.

### BACKGROUND

E-commerce has become ubiquitous. Indeed, e-commerce sales as a percent of retail sales have grown steadily at an annual rate of 12-17%. More and more e-commerce options are available and more and more consumers are taking advantage of purchasing items online. One challenge with e-commerce, in particular, is conversion of a web-browsing user into a bona fide purchaser.

### BRIEF DESCRIPTION OF THE FIGURES

These and other features, aspects, and advantages of the present disclosure are better understood when the following Detailed Description is read with reference to the accompanying drawings.

FIG. 1 illustrates an example architecture 100 in which a user may interact with the e-commerce website according to some embodiments described herein.

FIG. 2 is a flowchart of an example process 200 for selecting a shipping option with a high probability of conversion according to some embodiments described herein.

FIG. 3 is a flowchart of an example process 300 for recommending or providing a shipping option with a high probability of conversion according to some embodiments described herein.

FIG. 4 is a flowchart of an example process 400 for recommending or providing a shipping option with a high general probability of conversion according to some embodiments described herein.

FIG. 5 shows an illustrative computational system for performing functionality to facilitate implementation of embodiments described herein.

### DETAILED DESCRIPTION

Systems and methods are disclosed for determining shipping options for one or more online items listed for sale in an online marketplace that may increase an item's likelihood of conversion. Conversion is a term often used in electronic commerce to denote successfully changing a visitor to a paying customer. For example, it is common in electronic commerce for a user to populate an online virtual shopping cart with one or more items but not purchase those items. In this example, conversion did not occur because the user did not purchase the items. If, however, the user had purchased one or more of the items, conversion would have occurred for those one or more purchased items.

Conversion is unique to electronic commerce. Because it is a simple process to place items in an online virtual shopping cart it is also very easy to not actually purchase those items. Moreover, conversion can be important in electronic commerce as a way to boost sales and ultimately boost revenue.

In some embodiments, a user may not purchase an item from an electronic commerce site because the shipping options are unsatisfactory. For example, the shipping options may be too expensive or too slow or the shipping service may be unacceptable. Embodiments described herein may be used to provide shipping options that are more satisfactory or more acceptable to a potential buyer and may possibly increase the likelihood of conversion for one or more items. Embodiments described herein may also be used by online sellers or retailers to determine the best shipping options to provide to a buyer through the electronic commerce site to increase the likelihood of conversion.

Shipping options may include, for example, at least one of estimated delivery time, shipping costs, and shipping service. The shipping service, for example, may include at least one of the shipping carrier, the shipping manner (e.g., overnight, second day air, ground etc.), and the carrier type (e.g., truck, drone, fleet car, lockers, special delivery).

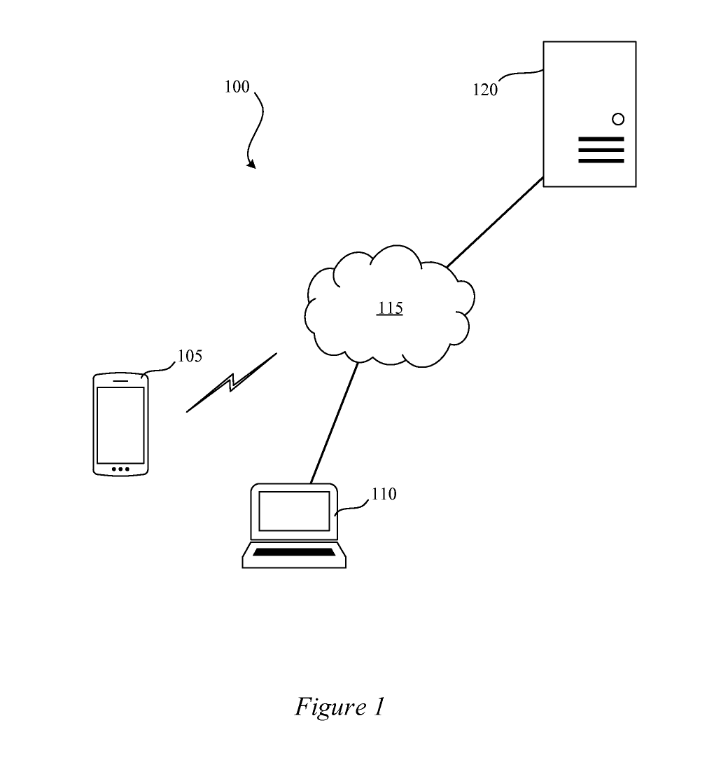

FIG. 1 illustrates an example architecture 100 in which a user may interact with the e-commerce website according to some embodiments described herein. The user may access an e-commerce website, for example, using a user device that may include a mobile device 105 or a computer 110. The user device, for example, may include a smart phone, a tablet, a laptop computer, a desktop computer, a smart watch, or some combination thereof. The user device may be coupled or connected to the network 115 either through a wired or wireless connection.

The e-commerce website may be hosted or maintained by server 120, which may include one or more servers distributed locally or broadly. A website hosted by the server 120 may provide one or more representations of items that may be purchased by a user. Images of these items as well as text describing these items may be sent to a user device through the network 115. The user may view the images and text using a web browser, an application, or an app on the user device. The website may provide a marketplace whereby users may shop for and purchase items listed at the marketplace. These items may be shipped or delivered to the user after being purchased by the user.

The network 115 may be any network or configuration of networks configured to send and receive communications between devices. In some embodiments, the network 115 may include a conventional type network, a wired or wireless network, and may have numerous different configurations. Furthermore, the network 115 may include a local area network (LAN), a wide area network (WAN) (e.g., the Internet), or other interconnected data paths across which multiple devices and/or entities may communicate. In some implementations, the network 115 may include a peer-to-peer network. The network 115 may also be coupled to or may include portions of a telecommunications network for sending data in a variety of different communication protocols. In some implementations, the network 115 includes Bluetooth® communication networks or a cellular communications network for sending and receiving communications and/or data including via short message service (SMS), multimedia messaging service (MMS), hypertext transfer protocol (HTTP), direct data connection, wireless application protocol (WAP), e-mail, etc. The network 115 may also include a mobile data network that may include third-generation (3G), fourth-generation (4G), long-term evolution (LTE), long-term evolution advanced (LTE-A), Voice-over-LTE (“VoLTE”) or any other mobile data network or combination of mobile data networks. Further, the network 115 may include one or more IEEE 802.11 wireless networks.

When a user selects an item to be purchased, the item is placed in a virtual shopping cart. The virtual shopping cart may organize one or more items that a user would like to purchase. The user may view a listing of items located in the virtual shopping cart on the user device. Shipping options may also be viewed. The user may also have the option of selecting from one or more different shipping options.

The user may purchase the item by providing payment details and selecting a desired shipping option or allowing the default shipping option to be used. Items that are purchased from the marketplace may be considered converted items. Alternatively, the user may also choose to not purchase the item and leave the items in the virtual shopping cart. Items that are not purchased from the marketplace may be considered non-converted items.

The server 120 may store information regarding converted items and information related to the converted items such as, for example, the item type, the shipping options used to ship the item, the time of year, the user profile, etc. The server 120 may store information related to the non-converted items such as, for example, the item type, the shipping options presented to the user, the time of year, the user profile, etc.

In some embodiments, the user profile data may be stored at the server. The user profile data may include information related to the user. This information may include, for example, demographic data, the age of the user, the location of the user, the shopping history of the user, the purchasing history of the user, the most recent items viewed by the user, the most recent items purchased by the user, the most recent items placed in the virtual shopping cart but not purchased, the preferred shipping options, credit card information, address, telephone number, etc.

For example, the user profile data may include previously purchased items and the associated shipping options used to ship the previously purchased items, and unpurchased items previously placed in a virtual shopping cart but not purchased and the associated shipping options presented in the virtual shopping cart with the unpurchased items. The user profile data may include this data for one user or any number of users.

In some embodiments, the user profile data may be stored in a database. The database may include data storage of user profile information. For example, the database may include user profile information that is stored based on a user's name, random ID, private ID, account number, or some other identifying number. The user profile information may include previous purchases by the user, previously purchased items and the associated shipping options used to ship the previously purchased items, unpurchased items previously placed in a virtual shopping cart but not purchased and the associated shipping options presented in the virtual shopping cart with the unpurchased items, internet traffic of the consumer, goals of the consumer, travel plans of the consumer, a calendar of the consumer, current planned purchases of the consumer, among other information about the consumer. The database may be configured to receive requests from the server 120.

In some embodiments, conversion probabilities may be determined from previously purchased items and previously unpurchased items for a single specific buyer. In other embodiments, conversion probabilities may be determined from previously purchased items and previously unpurchased items for a plurality of users.

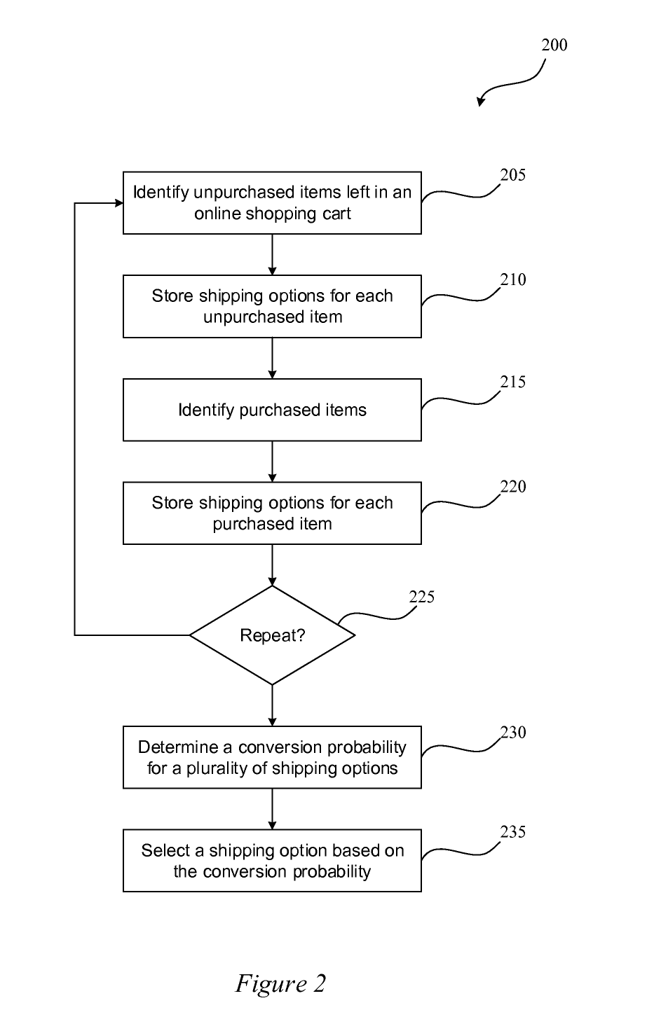

FIG. 2 is a flowchart of an example process 200 for selecting a shipping option with a high probability of conversion according to some embodiments described herein. One or more steps of the process 200 may be implemented, in some embodiments, by one or more components of server 120 of FIG. 1. Although illustrated as discrete blocks, various blocks may be divided into additional blocks, combined into fewer blocks, or eliminated, depending on the desired implementation.

Process 200 begins at block 205. At block 205, unpurchased items left in an online virtual shopping cart may be identified. Items may be considered unpurchased if they have been placed in a virtual shopping cart and not purchased for a particular period of time. For example, an item may be considered unpurchased if it is placed in a virtual shopping cart and not purchased within 5 to 10 days. These items may be considered to be non-converted items.

At block 210, the shipping options may be provided to the user in conjunction with the unpurchased items in the virtual shopping cart. For example, after an item is placed in the virtual shopping cart, the user may view the item in the virtual shopping cart. The marketplace may then present a webpage or other displayable items listing the item and possibly other items that have been placed in the virtual shopping cart. The marketplace may also present shipping options to the user. The shipping options, for example, may include shipping costs, estimated delivery time, shipping carrier, etc. Thus, the user may view the items in the virtual shopping cart as well as one or more shipping options. If the user then elects not to purchase these items, information describing these shipping options may be saved in conjunction with the items listed in the virtual shopping cart. Other information may also be saved such as, for example, the time of year, the type of item, etc.

At block 215, purchased items may be identified. At block 220, the shipping options used to ship the items may be identified and stored at the server 120. Other information may also be saved such as, for example, the time of year, the type of item, etc.

At block 225, it may be determined whether one or more of blocks 205, 210, 215, and 220 should be repeated. The blocks may be repeated, in order to identify and store shipping options of purchased and unpurchased items.

In some embodiments, the data collected and stored in blocks 205, 210, 215, and 220, may be data already collected and stored by the server 120. In some embodiments, the data may be collated to extract the shipping options presented to a user for unpurchased items and the shipping options used to ship purchased items, as well as other data.

At block 230 a conversion probability for one or more shipping options may be determined based on the data collected and stored in blocks 205, 210, 215, and 220. The conversion probability may predict the probability that a user will purchase an item in a virtual shopping cart based on the shipping options provided to the user.

In some embodiments, the conversion probability may be a function of at least one or more factors such as, for example, the time of year, the shipping options used in past purchases, user profile data, the shipping options provided to the user for unpurchased items, the shipping options available to the user based on the item type, whether the item type is similar to an item type of either a previously purchased or previously unpurchased item, the user's profile, the location of the seller, the location of the user, or some combination thereof. The user profile may include 55. Various other variables may be used.

In some embodiments, the user profile data may include statistics around historical data e.g. conversion rate for slow shipping, conversion rate for items with fast shipping, the age group of the user, the gender of the user, historical data regarding items or types of items the user is interested in (e.g. electronics vs. collections), etc.

In some embodiments, machine learning algorithms may be used to determine the conversion probability for each shipping option. For example, machine learning techniques such as logistic regression, support vector machines, gradient boosting machines can be used to predict the conversion probability for each shipping option using, for example, the user profile data; the factors described above; the data collected and stored in blocks 205, 210, 215, and 220; or some combination thereof. In some embodiments, machine learning algorithms may create a function for predicting probability given different factors such as, for example, the user profile data; item profile data; user historical interaction data; item historical interactions; the factors described above; the data collected and stored in blocks 205, 210, 215, and 220; or some combination thereof. The function may vary depending on the technique used. For example, in case of logistic regression, the machine learning algorithm may predict the coefficients for each factor and the prediction will be a logistic function.

In some embodiments, machine learning techniques may be used to determine or adjust at least one of functions, weighting factors, coefficients, constants, and significance thresholds in an algorithm used to determine the conversion probability of one or more shipping options. Adjustments to one or more of functions, weighting factors, coefficients, constants, and significance thresholds may be adjusted using machine learning techniques. An example machine learning technique may include neural networks or another suitable machine learning technique.

In some embodiments, a plurality of conversion probabilities may be determined for each of a plurality of shipping options. For example, if three shipping options are available—ground, second day air, and overnight—three conversion probabilities may be provided for each of these three shipping options. Each of the three conversion probabilities may be determined, for example, based on other factors described herein.

A conversion probability, for example, may be zero if the user never converts an item placed in the virtual shopping cart when a specific shipping option is provided. Conversely, a conversion probability, for example, may be one when the user always converts an item placed in the virtual shopping cart when a specific shipping option is provided. Conversion probabilities between zero and one may also be determined based on other various factors discussed herein.

Moreover, as discussed above, the conversion probabilities may also depend on the item type. Therefore, a conversion probability, for example, may be zero if the user never converts a specific item or an item of a specific item type that is placed in the virtual shopping cart when a specific shipping option is provided. Conversely, a conversion probability for example, may be one when the user always converts a specific item or an item of a specific item type when placed in the virtual shopping cart when a specific shipping option is provided.

In some embodiments, a conversion probability may be determined for an estimated delivery time, a shipping price, a shipping carrier, a shipping modality, or some combination thereof For example, the user may be more likely to convert an item when the shipping is free. As another example, the user may be more likely to convert an item when the shipping has an estimated delivery time of less than two days.

At block 235, a shipping option may be selected from one of the plurality of conversion probabilities. For example, if conversion probabilities are calculated for three shipping options, shipping option A with conversion probability of 0.75, shipping option B with a conversion probability of 0.44, and shipping option C with the conversion probability of 0.62, then the shipping option with the highest conversion probability, shipping option A, may be selected. This shipping option may be provided to the user in the virtual shopping cart to encourage the user to purchase the item. In some embodiments the shipping option may be provided to a third-party e-commerce website, which may provide the shipping option to the user to encourage conversion of the user to purchase the item.

In some embodiments, when two or more shipping options have similar or roughly similar conversion probabilities, then the lowest-priced shipping option, the fastest estimated delivery time shipping option, or a default shipping option may be selected. In some embodiments, the seller may select the default option at the time of creating the listing. One or more conversion probabilities may be roughly similar, for example, if the conversion probabilities differ by less than 10% or 5%.

In some embodiments, one or more of blocks 205, 210, 215, and 220 may occur independently of one or more of blocks 225, 230, and 235. For example, one or more of blocks 205, 210, 215, and 220 may occur each time a user places items in a virtual shopping cart and/or purchases items. Alternatively or additionally, one or more of blocks 205, 210, 215, and 220 may be performed on data specifying past items left in a virtual shopping cart and/or past items purchased.

For example, an e-commerce retailer may have collected shopping data over time that includes virtual shopping cart data, purchased item data, shipping data, shipping options provided to a user, conversion data, etc. One or more of blocks 205, 210, 215, and 220 may be performed using this previously collected shopping data.

In some embodiments, a shipping profile for a user or an item may be determined from the conversion probabilities. A shipping profile may indicate shipping options based on various factors such as, for example, based on the time of year, the item type, or some combination thereof. For example, the shipping profile may indicate the type of shipping options that will likely lead the given user to purchase a given item. For example, if a user frequently purchases healthcare products but only when the shipping is less than a certain amount, then the user's shipping profile may recommend providing shipping options with a shipping cost that is less than the certain amount for healthcare products. As another example, if a user only purchases items with a short estimated delivery time, then the shipping profile may recommend providing shipping options with a short delivery time. As yet another example, if the user never purchases an item in their virtual shopping cart when the shipping cost is above ten dollars and the estimated delivery time is greater than five days, then the shipping profile may recommend shipping options with a shipping cost that is less than ten dollars and with a shipping time that is less than five days.

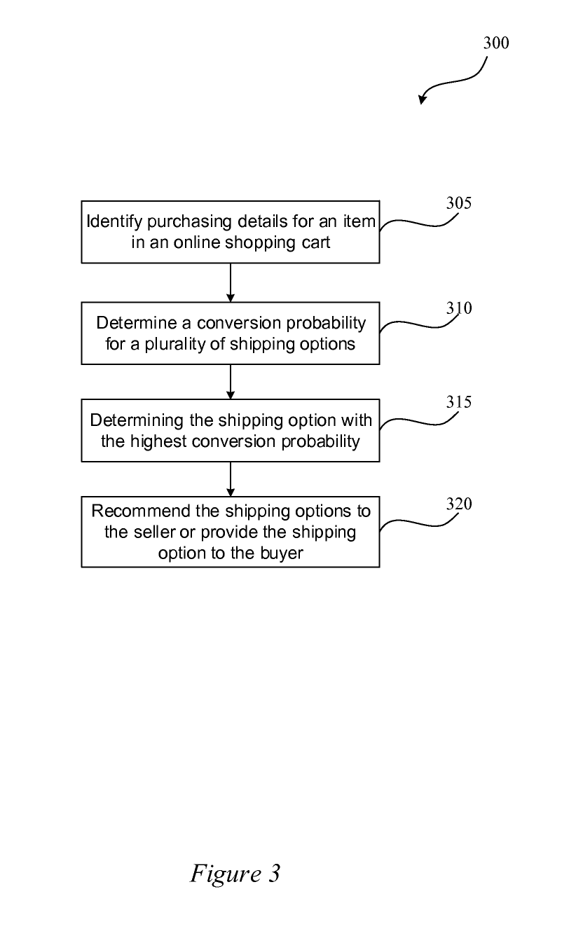

FIG. 3 is a flowchart of an example process 300 for recommending or providing a shipping option with a high probability of conversion according to some embodiments described herein. One or more steps of the process 300 may be implemented, in some embodiments, by one or more components of server 120 of FIG. 1. Although illustrated as discrete blocks, various blocks may be divided into additional blocks, combined into fewer blocks, or eliminated, depending on the desired implementation.

At block 305 the purchasing details for an item in an online virtual shopping cart may be received at server 120 from another e-commerce website and/or server or from memory associated with the server 120. These purchasing details may include, for example, one or more of the buyer, the buyer profile, the purchasing history of the buyer, the conversion history of the buyer, the non-conversion history of the buyer, the time of year, the item, the item type, the size of the item, and the weight of the item. The purchasing details, for example, may be stored in memory at the server 120 and/or at one or more other servers that are part of or separate from server 120.

At block 310 a conversion probability of a plurality of shipping options may be determined. Conversion probabilities for a plurality of shipping options may be determined in a manner similar to or the same as determined in block 230 of process 200 shown in FIG. 2.

At block 315 a shipping option may be selected from one of the plurality of conversion probabilities. For example, if conversion probabilities are calculated for three shipping options, shipping option A with a conversion probability of 0.75, shipping option B with a conversion probability of 0.44, and shipping option C with the conversion probability of 0.62, then the shipping option with the highest conversion probability, shipping option A, may be selected. This shipping option may be provided to the user in the virtual shopping cart to encourage the user to purchase the item. In some embodiments the shipping option may be provided to a third-party e-commerce website, which may provide the shipping option to the user to encourage conversion of the user to purchase the item.

In some embodiments, when two or more shipping options have similar or roughly similar conversion probabilities, then the higher-priced shipping option or the fastest estimated delivery time shipping option may be selected. One or more conversion probabilities may be roughly similar, for example, if the conversion probabilities differ by less than 10% or 5%.

At block 320 the shipping options with the highest conversion probability may be recommended to the seller of the item and/or provided to the buyer from the server 120. If the seller is another website and/or server and the purchasing details were received from this other website and/or server, then the shipping options with the highest conversion probability may be sent to the website and/or server. The other website and/or server may provide the shipping options with the highest conversion probability to the buyer.

If the server 120 also provides the e-commerce website with which the user is interacting and from which the user wishes to purchase an item, then the server 120 may present the shipping options with the highest conversion probability to the user through the website. For example, the shipping options with the highest conversion probability may be presented as a default shipping option.

In some embodiments, a general conversion probability and/or shipping options associated with a general conversion probability may be buyer agnostic. For example, a general conversion probability may be calculated based on one or more of an item, an item type, a cost of the item, a size of the item, a weight of the item, the time of year, the website from which the item is being purchased, and the number of other items in the shipping cart. But, for example, the general conversion probability may not depend on specific user data.

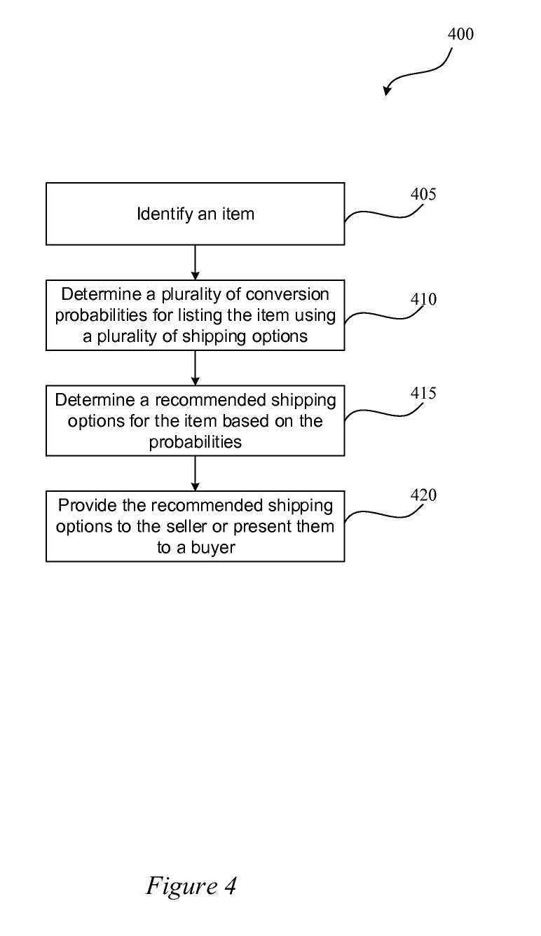

FIG. 4 is a flowchart of an example process 400 for recommending or providing a shipping option with a high general probability of conversion according to some embodiments described herein. One or more steps of the process 400 may be implemented, in some embodiments, by one or more components of server 120 of FIG. 1. Although illustrated as discrete blocks, various blocks may be divided into additional blocks, combined into fewer blocks, or eliminated, depending on the desired implementation.

At block 405, an item may be identified. The item may be identified, for example, from a message from a seller server that has requested general conversion probability data and/or shipping options, from a website where the item is being sold, and/or from a user.

Regardless of how the item is identified, a plurality of general conversion probabilities for listing the item with one of a plurality of shipping options may be determined at block 410. General conversion probabilities for a plurality of shipping options may be determined in a manner similar to or the same as determined in block 230 of process 200 shown in FIG. 2 except that each conversion probability may not be based on specific user information.

At block 415, a shipping option may be selected from one of the plurality of general conversion probabilities. For example, if conversion probabilities are calculated for three shipping options, shipping option A with conversion probability of 0.75, shipping option B with a conversion probability of 0.44, and shipping option C with the conversion probability of 0.62, then the shipping option with the highest conversion probability, shipping option A, may be selected. This shipping option may be provided to the user in the virtual shopping cart to encourage the user to purchase the item. In some embodiments, the shipping option may be provided to a third-party e-commerce website, which may provide the shipping option to the user to encourage conversion of the user to purchase the item.

In some embodiments, when two or more shipping options have similar or roughly similar general conversion probabilities, then the higher-priced shipping option or the fastest estimated delivery time shipping option may be selected. One or more general conversion probabilities may be roughly similar, for example, if the conversion probabilities differ by less than 10% or 5%.

At block 420, the shipping options with the highest general conversion probability may be recommended to the seller of the item and/or provided to the buyer from the server 120. If the seller is another website and/or server and the purchasing details were received from this other website and/or server, then the shipping options with the highest general conversion probability may be sent to the website and/or server. The other website and/or server may provide the shipping options with the highest general conversion probability to the buyer.

If the server 120 also provides the e-commerce website with which the user is interacting and from which the user wishes to purchase an item, then the server 120 may present the shipping option with the highest general conversion probability to the user through the website. For example, the shipping option with the highest general conversion probability may be presented as a default shipping option.

Embodiments described herein use the term “conversion probability” to include all numbers, scores, estimations, data, etc. that may be used to represent the likelihood of conversion of an item using first shipping options in comparison with other shipping options. The conversion probability may be represented using any scale or numbering system without limitation. The term “highest conversion probability” may indicate the conversion probability associated with one or more shipping options that provide the greatest likelihood of resulting in conversion. For example, one scale may indicate a high likelihood of conversion when the conversion probability is a minimum value of a plurality of conversion probabilities and another scale may indicate a high likelihood of conversion when the conversion probability is a maximum value of a plurality of conversion probabilities.

In some embodiments, shipping options for which a conversion probability may be determined may be made in response to a request from a third party website or from a process executing on the server 120. For example, the third party website or the server 120 may request at least one of conversion probability data and shipping recommendations by sending a request that includes at least one of an item, an item type, a location, data, buyer characteristics, a buyer profile, a plurality of shipping options, or some combination thereof) In response, a process may be executed at server 120 to produce conversion probability data based on one or more of the factors provided and in accordance with various embodiments described herein.

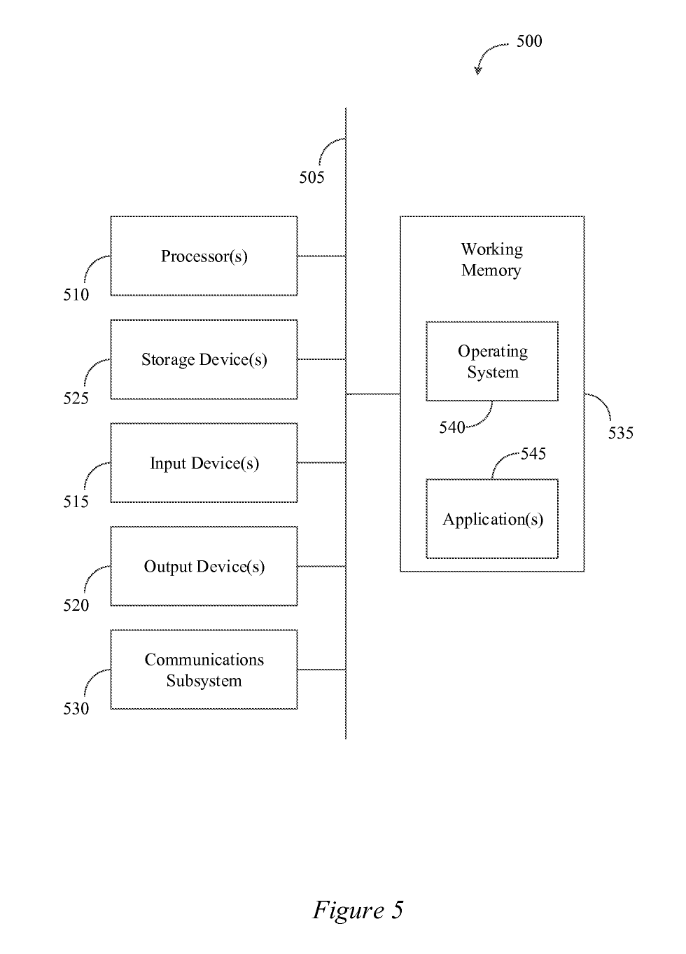

The computational system 500 (or processing unit) illustrated in FIG. 5 can be used to perform and/or control operation of any of the embodiments described herein. For example, the computational system 500 can be used alone or in conjunction with other components. As another example, the computational system 500 can be used to perform any calculation, solve any equation, perform any identification, and/or make any determination described here.

The server 120 may include one or more computational systems 500. Moreover, the process 200, the process 300 and the process 400 may be executed or controlled by the computational system 500. Moreover, the server 120 may include one or more components of computational system 500.

The computational system 500 may include any or all of the hardware elements shown in the figure and described herein. The computational system 500 may include hardware elements that can be electrically coupled via a bus 505 (or may otherwise be in communication, as appropriate). The hardware elements can include one or more processors 510, including, without limitation, one or more general-purpose processors and/or one or more special-purpose processors (such as digital signal processing chips, graphics acceleration chips, and/or the like); one or more input devices 515, which can include, without limitation, a mouse, a keyboard, and/or the like; and one or more output devices 520, which can include, without limitation, a display device, a printer, and/or the like.

The computational system 500 may further include (and/or be in communication with) one or more storage devices 525, which can include, without limitation, local and/or network-accessible storage and/or can include, without limitation, a disk drive, a drive array, an optical storage device, a solid-state storage device, such as random access memory (“RAM”) and/or read-only memory (“ROM”), which can be programmable, flash-updateable, and/or the like. The computational system 500 might also include a communications subsystem 530, which can include, without limitation, a modem, a network card (wireless or wired), an infrared communication device, a wireless communication device, and/or chipset (such as a Bluetooth® device, a 802.6 device, a WiFi device, a WiMAX device, cellular communication facilities, etc.), and/or the like. The communications subsystem 530 may permit data to be exchanged with a network (such as the network described below, to name one example) and/or any other devices described herein. In many embodiments, the computational system 500 will further include a working memory 535, which can include a RAM or ROM device, as described above.

The computational system 500 also can include software elements, shown as being currently located within the working memory 535, including an operating system 540 and/or other code, such as one or more application programs 545, which may include computer programs of the invention, and/or may be designed to implement methods of the invention and/or configure systems of the invention, as described herein. For example, one or more procedures described with respect to the method(s) discussed above might be implemented as code and/or instructions executable by a computer (and/or a processor within a computer). A set of these instructions and/or codes might be stored on a computer-readable storage medium, such as the storage device(s) 525 described above.

In some cases, the storage medium might be incorporated within the computational system 500 or in communication with the computational system 500. In other embodiments, the storage medium might be separate from the computational system 500 (e.g., a removable medium, such as a compact disc, etc.), and/or provided in an installation package, such that the storage medium can be used to program a general-purpose computer with the instructions/code stored thereon. These instructions might take the form of executable code, which is executable by the computational system 500 and/or might take the form of source and/or installable code, which, upon compilation and/or installation on the computational system 500 (e.g., using any of a variety of generally available compilers, installation programs, compression/decompression utilities, etc.), then takes the form of executable code.

Embodiments described herein include a method for selecting a shipping option based on conversion data. In some embodiments, the method may include receiving an indication that a buyer has placed an item in a virtual shopping cart at an electronic commerce website and retrieving from memory a buyer profile associated with the buyer. The method may also include determining from the buyer profile one or more conversion shipping options associated with shipping options used to ship one or more previously purchased items purchased by the buyer and determining from the buyer profile one or more non-conversion shipping options associated with shipping options presented to the buyer with one or more unpurchased items previously placed in a virtual shopping cart by the buyer but not purchased by the buyer. A plurality of conversion probabilities for a plurality of different shipping options be determined for the item in the virtual shopping cart based at least in part on the conversion shipping options and the non-conversion shipping options. The method may further include selecting a shipping option based on the plurality of different shipping options and the plurality of conversion probabilities and providing the selected shipping option.

In some embodiments, the method may further include identifying an item type associated with the item placed in the virtual shopping cart. In some embodiments, the determining the plurality of conversion probabilities is based at least in part on the identified item type and at least one of one or more item types associated with the one or more items placed in the virtual shopping cart but not purchased and one or more item types associated with the one or more items purchased by the buyer.

In some embodiments, the shipping options include at least one of an estimated delivery time, a shipping cost, and a shipping service.

In some embodiments, the method may include identifying a current time of year. The determining the plurality of conversion probabilities may be based at least in part on the current time of year and one or more dates associated with the one or more unpurchased items placed in the virtual shopping cart but not purchased and one or more dates when the one or more previously purchased items by the buyer were purchased.

In some embodiments, selecting a shipping option may include selecting one or more shipping options associated with a highest conversion probability of the plurality of conversion probabilities. In some embodiments, the plurality of conversion probabilities for a plurality of different shipping options may be determined using machine learning.

Some embodiments may include one or more non-transitory computer-readable media storing one or more programs that are configured, when executed, to cause one or more processors to execute any method described herein.

A system is also disclosed that may include a memory and computer server. The memory may include a plurality of buyer profiles that include previously purchased items and the associated shipping options used to ship the previously purchased items, and unpurchased items previously placed in a virtual shopping cart but not purchased and the associated shipping options presented in the virtual shopping cart with the unpurchased items. The computer server may be communicatively coupled with the memory and programmed to perform a number of operations. Operations may include receive an indication that a first buyer has placed a first item in a virtual shopping cart at an electronic commerce website; determine a plurality of conversion probabilities for a plurality of different shipping options for the item in the virtual shopping cart based at least in part on the shipping options used to ship the previously purchased items and non-conversion shipping options presented in the virtual shopping cart for unpurchased items previously placed in a virtual shopping cart but not purchased; select a shipping option based on the plurality of different shipping options and the plurality of conversion probabilities; and provide the selected shipping option to the electronic commerce website.

In some embodiments, the first item, the previously purchased items, and the unpurchased items comprise the same item. In some embodiments, the first item, the previously purchased items, and the unpurchased items comprise items having the same item type.

In some embodiments, the plurality of buyer profiles may include a buyer profile for the first buyer. In some embodiments, determining a plurality of conversion probabilities for a plurality of different shipping options may include determining a plurality of conversion probabilities for a plurality of different shipping options based at least in part on the shipping options used to ship the previously purchased items in the buyer profile for the first buyer profile and non-conversion shipping options presented in the virtual shopping cart for unpurchased items previously placed in a virtual shopping cart but not purchased in the buyer profile for the first buyer profile.

Embodiments described herein include a method for selecting a shipping option based on conversion data. The method may include determining one or more non-conversion shipping options associated with shipping options presented to one or more buyers that placed a specific item in one or more virtual shopping carts; determining one or more conversion shipping options associated with shipping options used by one or more buyers to ship the specific item upon purchase of the specific item; determining a plurality of conversion probabilities for a plurality of different shipping options for the specific item based at least in part on the conversion shipping options and the non-conversion shipping options; receiving a request from a seller for shipping recommendations for the specific item; and sending at least one of the shipping options for the specific items and the plurality of conversion probabilities to the seller.

In some embodiments, sending at least one of the shipping options for the specific items and the plurality of conversion probabilities to the seller includes sending the shipping options in order from highest conversion probability to lowest conversion. In some embodiments, the seller may include a third party seller.

Numerous specific details are set forth herein to provide a thorough understanding of the claimed subject matter. However, those skilled in the art will understand that the claimed subject matter may be practiced without these specific details. In other instances, methods, apparatuses, or systems that would be known by one of ordinary skill have not been described in detail so as not to obscure claimed subject matter.

Some portions are presented in terms of algorithms or symbolic representations of operations on data bits or binary digital signals stored within a computing system memory, such as a computer memory. These algorithmic descriptions or representations are examples of techniques used by those of ordinary skill in the data processing art to convey the substance of their work to others skilled in the art. An algorithm is a self-consistent sequence of operations or similar processing leading to a desired result. In this context, operations or processing involves physical manipulation of physical quantities. Typically, although not necessarily, such quantities may take the form of electrical or magnetic signals capable of being stored, transferred, combined, compared, or otherwise manipulated. It has proven convenient at times, principally for reasons of common usage, to refer to such signals as bits, data, values, elements, symbols, characters, terms, numbers, numerals, or the like. It should be understood, however, that all of these and similar terms are to be associated with appropriate physical quantities and are merely convenient labels. Unless specifically stated otherwise, it is appreciated that throughout this specification discussions utilizing terms such as “processing,” “computing,” “calculating,” “determining,” and “identifying” or the like refer to actions or processes of a computing device, such as one or more computers or a similar electronic computing device or devices, that manipulate or transform data represented as physical, electronic, or magnetic quantities within memories, registers, or other information storage devices, transmission devices, or display devices of the computing platform.

The system or systems discussed herein are not limited to any particular hardware architecture or configuration. A computing device can include any suitable arrangement of components that provides a result conditioned on one or more inputs. Suitable computing devices include multipurpose microprocessor-based computer systems accessing stored software that programs or configures the computing system from a general-purpose computing apparatus to a specialized computing apparatus implementing one or more embodiments of the present subject matter. Any suitable programming, scripting, or other type of language or combinations of languages may be used to implement the teachings contained herein in software to be used in programming or configuring a computing device.

Embodiments of the methods disclosed herein may be performed in the operation of such computing devices. The order of the blocks presented in the examples above can be varied—for example, blocks can be re-ordered, combined, and/or broken into sub-blocks. Certain blocks or processes can be performed in parallel.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Headings, lists, and numbering included herein are for ease of explanation only and are not meant to be limiting.

While the present subject matter has been described in detail with respect to specific embodiments thereof, it will be appreciated that those skilled in the art, upon attaining an understanding of the foregoing, may readily produce alterations to, variations of, and equivalents to such embodiments. Accordingly, it should be understood that the present disclosure has been presented for purposes of example rather than limitation, and does not preclude inclusion of such modifications, variations, and/or additions to the present subject matter as would be readily apparent to one of ordinary skill in the art.

That which is claimed:

1. A method comprising:
receiving an indication that a buyer has placed an item in a virtual shopping cart at an electronic commerce website;
retrieving from memory a buyer profile associated with the buyer;
determining from the buyer profile one or more conversion shipping options associated with shipping options used to ship one or more previously purchased items purchased by the buyer;
determining from the buyer profile one or more non-conversion shipping options associated with shipping options presented to the buyer with one or more unpurchased items previously placed in a virtual shopping cart by the buyer but not purchased by the buyer;
determining a plurality of conversion probabilities for a plurality of different shipping options for the item in the virtual shopping cart based at least in part on the conversion shipping options and the non-conversion shipping options;
selecting a shipping option based on the plurality of different shipping options and the plurality of conversion probabilities; and
providing the selected shipping option.

2. The method according to claim 1, further comprising identifying an item type associated with the item placed in the virtual shopping cart, wherein determining the plurality of conversion probabilities is based at least in part on the identified item type and at least one of one or more item types associated with the one or more items placed in the virtual shopping cart but not purchased and one or more item types associated with the one or more items purchased by the buyer.

3. The method according to claim 1, wherein the shipping options include at least one of an estimated delivery time, a shipping cost, and a shipping service.

4. The method according to claim 1, further comprising identifying a current time of year, wherein determining the plurality of conversion probabilities is based at least in part on the current time of year and one or more dates associated with the one or more unpurchased items placed in the virtual shopping cart but not purchased and one or more dates when the one or more previously purchased items by the buyer were purchased.

5. The method according to claim 1, wherein the selecting a shipping option comprises selecting one or more shipping options associated with a highest conversion probability of the plurality of conversion probabilities.

6. The method according to claim 1, wherein the plurality of conversion probabilities for a plurality of different shipping options is determined using machine learning.

7. One or more non-transitory computer-readable media storing one or more programs that are configured, when executed, to cause one or more processors to execute the method as recited in claim 1.

8. A system comprising:
a memory including a plurality of buyer profiles that include previously purchased items and the associated shipping options used to ship the previously purchased items, and unpurchased items previously placed in a virtual shopping cart but not purchased and the associated shipping options presented in the virtual shopping cart with the unpurchased items;
a computer server communicatively coupled with the memory and programmed to:
receive an indication that a first buyer has placed a first item in a virtual shopping cart at an electronic commerce website;
determine a plurality of conversion probabilities for a plurality of different shipping options for the item in the virtual shopping cart based at least in part on the shipping options used to ship the previously purchased items and non-conversion shipping options presented in the virtual shopping cart for unpurchased items previously placed in a virtual shopping cart but not purchased;
select a shipping option based on the plurality of different shipping options and the plurality of conversion probabilities; and
provide the selected shipping option to the electronic commerce website.

9. The system according to claim 8, wherein the first item, the previously purchased items, and the unpurchased items comprise the same item.

10. The system according to claim 8, wherein the first item, the previously purchased items, and the unpurchased items comprise items having the same item type.

11. The system according to claim 8, wherein
the plurality of buyer profiles comprises a buyer profile for the first buyer; and
the determining a plurality of conversion probabilities for a plurality of different shipping options comprises determining a plurality of conversion probabilities for a plurality of different shipping options based at least in part on the shipping options used to ship the previously purchased items in the buyer profile for the first buyer profile and non-conversion shipping options presented in the virtual shopping cart for unpurchased items previously placed in a virtual shopping cart but not purchased in the buyer profile for the first buyer profile.

12. The system according to claim 8, wherein the shipping options include at least one of an estimated delivery time, a shipping cost, and a shipping service.

13. The system according to claim 8, further comprising identifying a current time of year, wherein determining the plurality of conversion probabilities is based at least in part on the current time of year and one or more dates associated with the previously purchased items and the unpurchased items.

14. The system according to claim 8, wherein the selecting a shipping option comprises selecting one or more shipping options associated with a highest conversion probability of the plurality of conversion probabilities.

15. A method comprising:
determining one or more non-conversion shipping options associated with shipping options presented to one or more buyers that placed a specific item in one or more virtual shopping carts;
determining one or more conversion shipping options associated with shipping options used by one or more buyers to ship the specific item upon purchase of the specific item;
determining a plurality of conversion probabilities for a plurality of different shipping options for the specific item based at least in part on the conversion shipping options and the non-conversion shipping options;
receiving a request from a seller for shipping recommendations for the specific item; and
sending at least one of the shipping options for the specific items and the plurality of conversion probabilities to the seller.

16. The method according to claim 15, wherein sending at least one of the shipping options for the specific items and the plurality of conversion probabilities to the seller comprises sending the shipping option corresponding to a highest conversion probability.

17. The method according to claim 15, wherein sending at least one of the shipping options for the specific items and the plurality of conversion probabilities to the seller comprises sending the shipping options in order from highest conversion probability to lowest conversion.

18. The method according to claim 15, wherein at least one of the shipping options include at least one of an estimated delivery time, shipping cost, and shipping service.

19. The method according to claim 15, wherein the seller comprises a third party seller.

20. One or more non-transitory computer-readable media storing one or more programs that are configured, when executed, to cause one or more processors to execute the method as recited in claim 15.
